(19) United States
(12) Patent Application Publication
(10) Pub. No.: US 2026/0022068 A1
(43) Pub. Date: Jan. 22, 2026

(54) High Compressive Strength Polymer Grout and Method for Making

(71) Applicants: Lawrence S. Shapiro, Branford, CT (US); Scott Atom Saverse, New Haven, CT (US); Douglas A. Cheney, Waterbury, CT (US); Zbigniew Andrew Szczepaniak, New Britain, CT (US)

(72) Inventors: Lawrence S. Shapiro, Branford, CT (US); Scott Atom Saverse, New Haven, CT (US); Douglas A. Cheney, Waterbury, CT (US); Zbigniew Andrew Szczepaniak, New Britain, CT (US)

(21) Appl. No.: 18/779,062

(22) Filed: Jul. 21, 2024

(51) Int. Cl. C04B 26/14; C04B 14/06; C04B 24/12; C04B 103/14; C04B 103/40; C04B 111/70

(52) U.S. Cl. CPC C04B 26/14; C04B 14/06; C04B 24/121; C04B 2103/14; C04B 2103/40; C04B 2111/70; C04B 2201/52

(57) ABSTRACT

A thermosetting three-part epoxy grout composition includes: a resin comprising at least 20 wt. % resorcinol diglycidyl ether, a liquid curing agent, and a dry particulate filler comprising particles having a blend of particle sizes and amounting to at least 70% of the combined volume of the particulate filler, the resin, and the hardener. The polymer grout has a compressive strength at 28 days of at least 25,000 psi. The inventive compositions are particularly suitable as transition structures in foundations for wind towers and other constructions.

### BACKGROUND OF THE INVENTION

### Field of the Invention

The invention pertains to construction materials and methods. More particularly, the invention pertains to high compressive strength grouts useful in the placement of towers onto concrete foundations and other uses in the civil engineering art.

### Description of Related Art

Polymer grout is a composite material used extensively in new construction, particularly in the placement of wind towers and other structures onto reinforced concrete foundation pads. Such grouts are also used in repair and restoration projects, particularly in restoring marine piles. Particular compositions have been developed to suit the needs of particular applications, including strength, thermal expansion, workability, fluidity, and of course, cost. There is a continuing need for grouts with higher compressive strength as the construction industry seeks taller structures and more structurally efficient and cost effective designs.

Polymer grout compositions are most commonly supplied as a three-part thermosetting resin system, in which Part A comprises a monomer or monomer blend, Part B comprises a hardener or catalyst, and Part C comprises a dry inorganic aggregate mix. The system may further include such additives as reactive diluents, surfactants, defoaming agents, accelerators, plasticizers, and adhesion promoters, which may be incorporated in one or more of Parts A, B, and C by the manufacturer. The grout is often supplied to the field in the form of a kit containing premeasured buckets of Parts A and B and premeasured sacks of dry aggregate (Part C) such that one kit will make a predetermined volume of grout and no measuring of the individual components is needed on the job site. The roles of the various components in Parts A and B may be summarized as follows:

Monomers are typically diglycidyl ethers familiar in the art of two-part epoxy systems, such as bisphenol A, bisphenol F, bisphenol E, neopentylglycol, and aliphatic and aromatic mono- and di-glycidyl ethers thereof.

Reactive diluents include resorcinol diglycidyl ether (RDGE), benzyl alcohol, and many others. Their role is to reduce the viscosity of the mixture for better pouring, pumping, or workability. They are called reactive diluents because they will participate in the polymerization reactions and become incorporated into the polymer network, in some cases as a chain termination.

Curing agents or hardeners commonly available for epoxy systems include cyclohexanemethanamine, 5-amino-1,3,3-trimethyl-, any cycloaliphatic mono-, di-, and tri-amine, isophoronediamine (IPDA), aliphatic amines, and aromatic amines.

Adhesion promoters are commonly available for epoxy curing agents, including amino functional silanes, waterborne silanes, and glycidoxy functionalized silanes. Depending on their particular functionality, these components may be added to Part A or Part B.

Plasticizers include, e.g., polyoxypropylenediamine of a selected molecular weight; their role is to improve flexibility and decrease brittleness of the cured material.

Conventionally, grout formulations have not relied on resorcinol diglycidyl ether (RDGE) as the main resin, but rather as a minor component added to serve as a reactive diluent. Among other reasons, the cost of RDGE (˜$19.00/lb) is significantly higher than that of conventionally used monomers such as bisphenol A DGE (˜$1.80/lb). Also, it is known to exhibit higher skin sensitization compared to standard epoxy monomers.

U.S. Pat. Appl. Pub. 2022/0098439 by Treadway teaches the use of RDGE and other monoaromatic diglycidyl ethers in UV-cured transparent optical coatings for applications such as eyeglass lenses.

U.S. Pat. No. 8,986,799 by Jackson et al. teaches the use of epoxy resins containing 60-80% RDGE and 20-40% epoxy novolac resin for use as a coating for the inner linings of cargo tanks. The coatings are said to have very low absorption for liquid chemicals that are transported in cargo tanks and also to be resistant to cyclic loading.

U.S. Pat. Appl. Pub. 2022/0112395 by Gasa et al. teaches an epoxy coating composition including novolac epoxy, bisphenol F, bisphenol A, and RDGE in an amount of 3-30% of Part A. Coatings between 5 and 20 mm thick are said to be corrosion and wear resistant.

### Objects and Advantages

Objects of the present invention include the following: providing an ultra-high strength grout composition having similar flow characteristics to conventional grouts for similar applications; providing a grout having a polymer matrix with inherently high compressive strength suitable for use with a wide variety of inorganic aggregates; providing a method of making polymer-based grout; providing a prepackaged grout mix that will yield a very high compressive strength grout; and providing a polymer grout composition having compressive strength that is better matched to steel components with which the grout will engage in a finished structure. These and other objects and advantages of the invention will become apparent from consideration of the following specification, read in conjunction with the drawings.

### SUMMARY OF THE INVENTION

According to one aspect of the invention, a three part polymer grout formulation comprises:
a liquid epoxy resin comprising at least 30 wt. % resorcinol diglycidyl ether;
a liquid curing agent;
a dry particulate filler comprising particles having a blend of particle sizes and amounting to at least 70% of the combined volume of the particulate filler, the resin, and the hardener; and,
   wherein the polymer grout has a compressive strength at 28 days of at least 23,000 psi.

According to another aspect of the invention, a foundation system for a tower comprises:
a cast in place reinforced concrete foundation comprising two concentric rings of bolts extending a selected distance upward from its upper surface;
a cast in place polymer grout ring formed on top of the foundation and extending a first selected distance outward beyond the outer concentric ring, a second selected distance inward beyond the inner concentric ring, and a third selected distance upward, leaving the two concentric rings of bolts partially exposed above the grout so that a metal tower may be bolted directly upon the polymer grout;
wherein:
   the reinforced concrete has a compressive strength of at least 3000 psi;
   the polymer grout has a compressive strength at 28 days of at least 23,000 psi;
   the resin component contains at least 20 wt. % of a diglycidyl ether of a monoaromatic monomer and is substantially free of novolac; and,
   the polymer grout contains at least 70% by volume of inorganic aggregate.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 is a comparison of compressive strength for three grout formulations made using the inventive RDGE monomer system with various aggregates versus a commercially available high strength grout formulation.

FIG. 2 is plot of compressive strength of grouts made with conventional resin versus RDGE resin for the same aggregate types shown in FIG. 1.

FIG. 3 is plot of compressive strength of grouts made with one aggregate type and varying proportions of RDGE displacing Bis-F DGE in the resin.

FIG. 4 is plot of compressive strength of grouts made with one aggregate type and varying proportions of RDGE displacing (Bis-F DGE+Neopentyl DGE) in the resin, to minimize changes in resin viscosity.

FIG. 5 is a comparison of the CTE of concrete, steel, and various polymer grout materials (ustrain/° F.).

### DETAILED DESCRIPTION OF THE INVENTION

The invention is a family of compositions suitable for making polymer grouts having greatly increased compressive strength, for use as construction materials. The epoxy grouts are based on two-part resin systems in which certain monomers, such as resorcinol diglycidyl ether (RDGE) make up some, most, or virtually all of Part A, while Part B may contain any suitable hardening agents as are well known in the art, such as mono-, di- and tri-amine compounds. Part C may be any suitable inorganic aggregate mixture, as are well known in the art, with a controlled size distribution that allows a very high solids loading to be achieved while preserving adequate fluidity and workability.

In the examples that follow, it will become apparent to the skilled artisan that the inventive formulations can produce unprecedented increases in compressive strength relative to conventional resin formulations employing similar aggregate characteristics.

### Example

A comparative test was run using as a baseline a commercial ultra-high strength grout product (XP230, Five Star Products, Inc., Shelton, CT) having a cured strength of about 28,000 psi. Further details of this material and the aggregate characteristics are described in Applicant's co-pending U.S. patent application Ser. No. 17/983,369, entitled, “High Compressive Strength Polymer Grout and Method for Making”, the entire disclosure of which is incorporated herein by reference.

The Part A formulation replaced 100% of the Bis-F resin with RDGE so that Part A comprised 90.8% RDGE and 9.2 wt. % neopentyl glycol DGE (Chemmod® 68 reactive diluent, Cargill, Inc., Minneapolis, MN), Table1.

TABLE 1
Part A composition

| Component | Range (wt. %) | Intended role |
|---|---|---|
| Epoxy resin blend^{a} | 95-100 | reactive resin, structural |
| Surfactant^{b} | 0-5 | flow, levelling, surfactant |

^{a}90.8 wt. % RDGE and 9.2 wt. % neopentyl glycol DGE
^{b}Modaflow ® Resin, Acrylic Copolymer, (Allnex USA Inc.), BYK 066N or BYK A-535 (BYK Chemie, Wallingford, CT), 2,6-Dimethylheptan-4-one, 4,6-Dimethyl-2-heptanone, mineral oil, benzyl alcohol or any suitable air controlling additive. This may include plasticizers or other ingredients that function synergistically in either the Part B or Part A compositions.

The Part B formulation was the same hardener system used in the baseline XP230 product, Table 2.

TABLE 2
Part B composition

| Component | Range (wt. %) | Intended role |
|---|---|---|
| Epoxy curing agents blend^{a} | 95-100 | Curing agent, structural |
| Surfactant^{b} | 0-5 | Viscosity diluent, |
| | | accelerator |

^{a}Any standard curing agent as are known in the art
^{b}Can be BYK-066N or BYK A-535 (BYK USA Inc., Wallingford CT), mineral oil, or other surfactants listed as air release or defoaming agents. This may include plasticizers or other ingredients that function synergistically in either the Part B or Part A compositions.

Those skilled in the art will appreciate that many curing agents are commonly available for epoxy systems, including cyclohexanemethanamine, 5-amino-1,3,3-trimethyl-, any cycloaliphatic mono-, di-, and tri-amine, isophoronediamine (IPDA), aliphatic amines, and aromatic amines. Those skilled in the art will further appreciate that many commercially available adhesion promoters are commonly available for epoxy curing agents, e.g., amino functional silanes, such Silquest, A-1100 A-1110, A-1120 (J), A-2120, A-1170, Y-9627, Y-11699, A-1524, A-Link 15, or even VS 142, A-1106 (waterborne) silanes and similar ones, as adhesion promoters, are good for addition to epoxy hardeners for a simple reason: they do not react with the hardener and they are stable in its environment. On the other hand, glycidoxy functionalized silanes like Silquest A-186, A-187, A-1871 and others are added to epoxy resin for the same reason, the same functionality. Also, other reactive functionalities might be used in epoxy such as (meth)acrylic—e.g. Silquest A-174NT Silane which would also react with amine-epoxy based system, but are stable in epoxy. Those skilled in the art will appreciate that in some circumstances it is possible to mix the additive (here adhesion promoter) with the opposite functionality (e.g. amine based promoter with epoxy). The adhesion promoter would then react here with the epoxy (or in the opposite case, with the amine) making, after the reaction, the promoter molecule much bigger, less mobile, less reactive. This methodology is possible, however in most cases it would be less effective and desirable. For the present application, suitable epoxy curing agent blends typically have a viscosity in the range of 30 to 800 cps.

The Part C (aggregate) was varied for the three test runs, as summarized in the following table. In all four runs the aggregate was held constant at 80.6 vol. % (Part C vs. total of Parts A+B+C)

TABLE 3
Properties of RDGE grouts with different aggregate mixes.

| | | | Comp. Strength, |
|---|---|---|---|
| Part A | Part B | Part C | psi |
| 90.8 wt. % RDGE | XP hardener^{d} | XP230 std^{a} | 32,000 |
| 9.2 wt. % NGDGE | | | |
| 90.8 wt. % RDGE | XP hardener | VOCA^{b} | 30,700 |
| 9.2 wt. % NGDGE | | | |
| 90.8 wt. % RDGE | XP hardener | Carbo^{c} | 33,100 |
| 9.2 wt. % NGDGE | | | |
| Baseline | | | |
| 90.8 wt. % Bis-F | XP hardener | XP230 std^{a} | 28,000 |
| 9.2 wt. % NGDGE | | | |

^{a}See U.S. patent application 17/983,369
^{b}XP230 with #3 sand replaced by VOCA 16/30
^{c}68 wt. % Carbobead Max 25 HD, 18 wt. % Carbobead CP 40/170, 14 wt. % Fly Ash C
^{d}XP230 hardener, Table 2

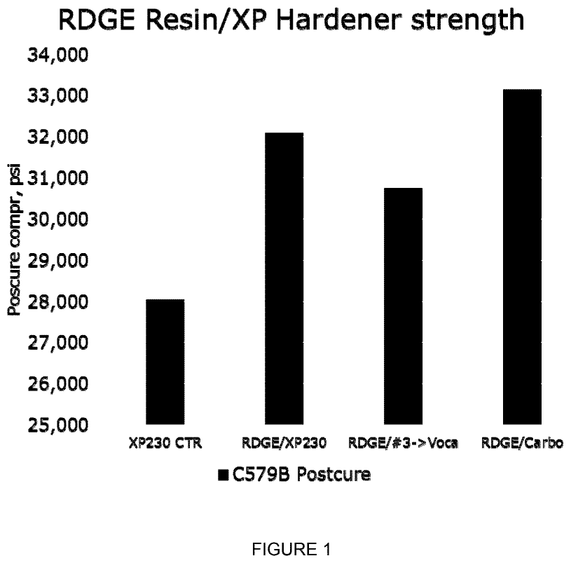

FIG. 1 shows the strength comparison of the four samples, demonstrating the significant increases in strength for all samples relative to the conventional (baseline) product.

### Example

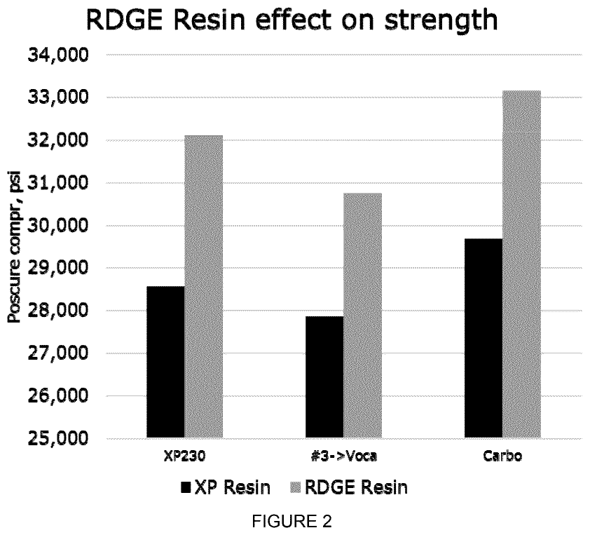

As a further comparison, batches were made using the same aggregate mixes as in the previous example, but using the standard XP resin mix (90.8 wt. % Bis-F, 9.2 wt. % NGDGE). FIG. 2 shows a side-by-side comparison in which it is clear that the inventive RDGE resin system imparts considerable strength increases regardless of the particular aggregate chosen.

### Example

The initial resin discovery compared a baseline resin (Bis-F DGE and Neopentyl DGE) to one in which some of the Bis-F was replaced by RDGE. One of the experiments using 47.1% of Resorcinol DiGlycidyl Ether (RDGE) yielded an unexpectedly higher result. Applicants had speculated that RDGE would increase the strength somewhat (because it is a smaller, less complicated epoxy monomer), but the results, Table 4, were unexpectedly higher. Formula 3-148C vs. exp. 3-147D were using the same aggregate and the same hardener. The only difference between the two formulas was the 47.1% Bis-F replacement with RDGE. The result, a strength gain of 3,000 psi, was remarkable.

TABLE 4
Strength gains on the addition of 47.1% RDGE in resin
blend. Postcures were done at 140° F. for 24
hrs. Both formulas used the same aggregate loading.

| Formula | 3-147D | 3-148C |
|---|---|---|
| Part A | | |
| Bis F DGE, % | 76.7 | 29.4 |
| Neopentyl DGE, % | 23.3 | 23.3 |
| Resorcinol DGE, % | — | 47.1 |
| Part B | | |
| Amine Hardener, phr | 28 | 28 |
| Stochiometry (Resin >1 or A/B) | 1.00 | 1.00 |
| ASTM C579B results: | | |
| Compressive strength | 29,517 | 32,426 |
| postcure, psi | | |
| Compressive strength | 29,319 | 32,365 |
| postcure, psi | | |
| Compressive strength | 28,573 | 32,049 |
| postcure, psi | | |
| Average, psi | 29,136 | 32,320 |
| Standard deviation, psi | 406 | 165 |

It will be appreciated that strength improvements in materials such as these are typically achieved in very small increments, typically hundreds of psi; the skilled artisan will recognize that the compressive strengths given in Tables 3 and 4 represent improvements of 3000-5000 psi, which is an extraordinary increase.

As noted above, aggregate mixtures as taught generally in U.S. patent application Ser. No. 17/938,369 are particularly suitable for use with the inventive resin systems. One aggregate mixture taught therein comprises 30 to 70% of a first particulate material having a size range of +16 mesh; 10 to 40% of a second particulate material having size range of −16 to +40 mesh; 5 to 30% of a third particulate material having size range of −40 to +140 mesh; and, a fourth particulate material comprising fine filler. The fourth material (fine filler) may preferably comprise fly ash. The particulate filler may be pretreated with an applied adhesion promoter in an amount of 0.1 to 2 wt. %. Some suitable adhesion promoters include amino functional silanes, glycidoxy functionalized silanes, (meth)acrylic functionalized silanes, and other reactive functionalized silanes.

### Example

This experiment was designed to determine the relationship between the % replacement of Bis-F epoxy resin with RDGE and the resulting ultimate compressive strength. In the following experiment Bis-F DGE was gradually replaced with RDGE (independent variable) and the postcure compressive strength was measured (dependent variable). Postcures were done @140° F. for 24 h then cooled to RT. All formulas were made using the same 80.6 vol. % loading of “XP 230” aggregate. The amount of the hardener (SP Hardener) had to be balanced to the same stoichiometry because RDGE had much lower EEW (Epoxy Equivalent Weight) than Bis-F. Compressive strength was measured according to ASTM C579B, Table 5.

TABLE 5
Effect of RDGE content on compressive strength

| Formula | A | B | C | D | E |
|---|---|---|---|---|---|
| Part A | control | | | | |
| Bis F DGE, % | 90 | 67.5 | 45 | 22.5 | — |
| Neopentyl DGE, % | 10 | 10 | 10 | 10 | 10 |
| Resorcinol DGE | — | 22.5 | 45 | 67.5 | 90 |
| (THOR^{a}), % | | | | | |
| Part B | | | | | |
| Amine Hardener, phr | 26 | 29 | 32 | 35 | 39 |
| Properties | | | | | |
| Kinematic viscosity | 2980 | 1320 | 640 | 330 | 180 |
| (cPs) - Part A | | | | | |
| Stochiometry | 1.00 | 1.00 | 1.00 | 1.00 | 1.00 |
| (Resin >1 or A/B) | | | | | |
| ASTM C579B results | | | | | |
| Compressive | 28,090 | 30,091 | 29,356 | 31,896 | 32,776 |
| strength postcure, psi | | | | | |
| Compressive | 28,350 | 29,620 | 29,101 | 31,619 | 32,452 |
| strength postcure, psi | | | | | |
| Compressive | 29,016 | 28,535 | 30,339 | 30,392 | 30,828 |
| strength postcure, psi | | | | | |
| Average, psi | 28,480 | 29,410 | 29,600 | 31,300 | 32,020 |
| Standard deviation, | 390 | 652 | 534 | 654 | 852 |
| psi | | | | | |
| Average % air in | 4.1% | 3.4% | 3.6% | 3.5% | 3.2% |
| 2-inch cube | | | | | |

^{a}THOR is an internal designation given to RDGE compositions during early experimental work

### Example

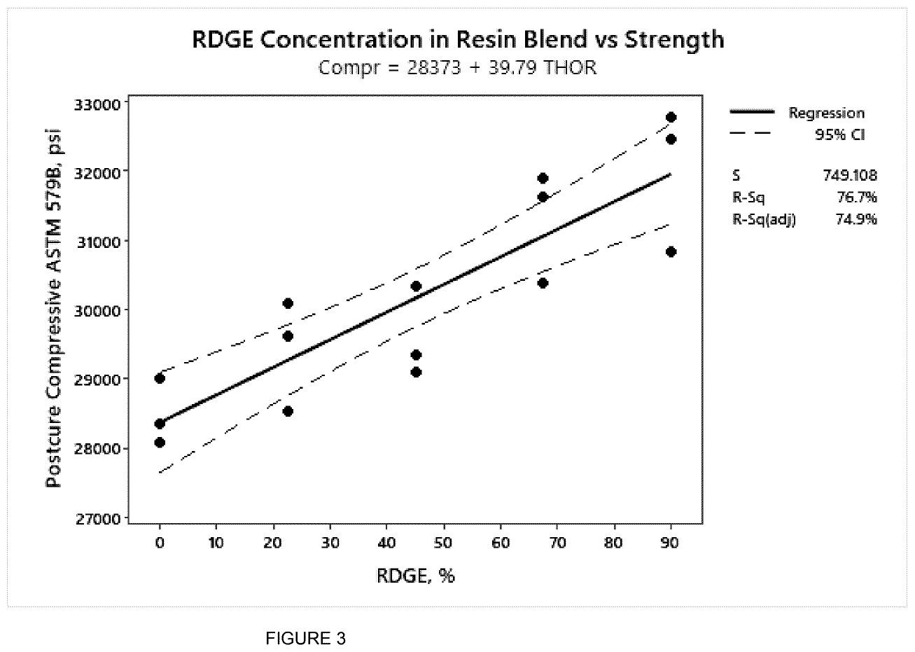

FIG. 3 presents compressive strength values (ASTM C579B) versus RDGE concentration in the resin blend.

The regression formula of this series is: Compressive=28,373 psi+(% RDGE)×(39.79 psi) indicating that there was an increase in strength of 39.8 psi per 1% of RDGE.

One might argue that viscosities of part A in those five formulas above were so different that this might have possibly influenced the strength. The argument would be that the higher viscosity resins might trap more air during mixing with aggregate, and thereby weaken the material. However, the calculations of air content in the cubes showed that the amount of air trapped in the cured material was very close in all specimens.

Nevertheless, another experiment was designed to address viscosity differences (below). In the previous experiment only Bis-F DGE was replaced with RDGE and the Neopentyl DGE was kept constant. This time the 75/25 blend of Bis-F DGE and Neopentyl DGE was replaced with RDGE. The RATIO of Bis-F to Neopentyl was kept constant. Again, stoichiometry had to be balanced out with amine hardener (to 1.0).

### Example

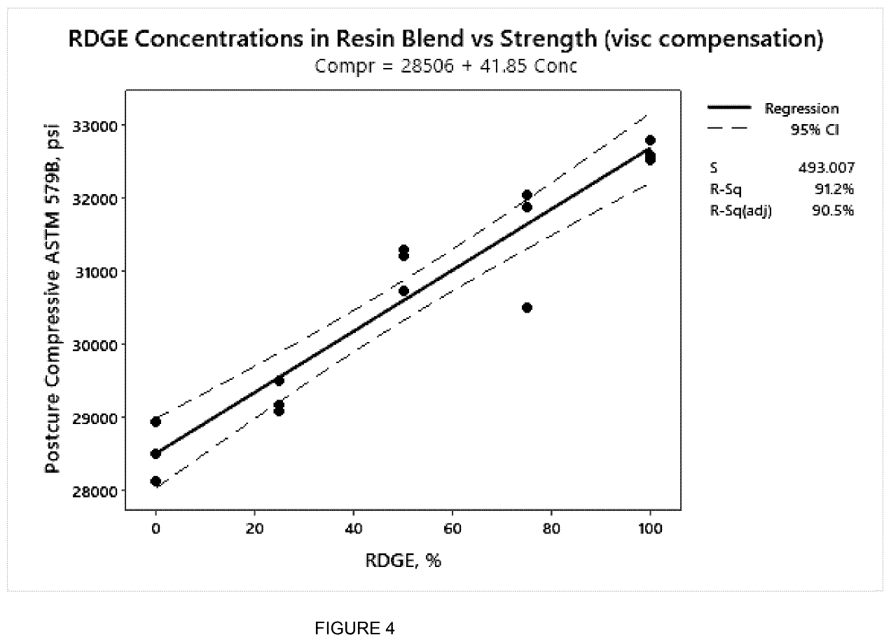

FIG. 4 presents compressive strength values (ASTM C579B) versus RDGE concentration in resin blend. In this example, the ratio of Bis-F to Neopentyl was kept constant as the RDGE was increased, thereby keeping the viscosity relatively constant.

For these tests, the regression formula was Compressive=28,506 psi+(% RDGE)×(41.8 psi), indicating that there was an increase in strength of 41.8 psi per 1% of RDGE. This was consistent with the previous study results. Furthermore, the results show similar air content, which at this level would have no effect on the compressive strength.

Applicants therefore conclude that the use of RDGE creates a significantly higher compressive strength material.

In early studies on potential high strength materials, Applicants considered novolacs, but their use led to generally disappointing results. However, some reports (see, e.g., U.S. Pat. Appl. Pub. 2022/0112395 by Gasa et al.) suggest that novolac resins might be useful to increase compressive strength. The thought was that higher functionality of novolac resins would increase cured polymer density and thus the strength. The following example describes an additional test on novolac resins and resulting compressive strength.

### Example

Chemistry: Novolac resins are monomers derived, like Bis-F, from phenol and formaldehyde. The difference is they have a degree of polymerization (higher than Bis-F) and when reacted with epichlorohydrin the functionality number is higher than 2 on one molecule. Epon™ SU-8 (Miller-Stephenson Chemical Co., 55 Backus Ave.

Danbury, CT 06810) has a functionality of 8 and it is the highest functionality novolac resin available on the market. This resin is in a solid form at room temperature and it needs to be heated and dissolved in low viscosity resins before use. It seemed to be logical to select this resin as a perfect candidate for the study.

Experimental: There were some steps required prior to the use of novolac resin (as-received, novolac is in a solid form).
1. SU-8 was heated to 200° F. and mixed with Chemmod 68 (neopentyl glycol diglycidyl ether) and cooled down to room temperature.
2. The ratio SU-8/Chemmod 68 obtained was 65/35 respectively.
3. The measured viscosity was still very high 27,500 cPs and this mixture needed to be dissolved further down to usable viscosity <5,000 cPs.
4. The above mixture was used to design the experiments below, Table 6. The level of Chemmod 68 was adjusted to the same level of 24% as the control “A”. Although Chemmod 68 is known to be difunctional, it would still affect the strength if the level was changed. So only Bis F was being replaced with SU-8 as aromatic resin for aromatic resin.
5. Stoichiometry in all formulas was adjusted to 1.0 since EEW of the resin blends with SU-8 addition was changing.

Observation: There was no indication of the strength increase for both 7 days RT and postcure strengths. A strength loss was noted, especially apparent in ultimate postcure strength. Also, it must be noted that the last formula ‘D’ was already difficult to mix because of its elevated viscosity.

Summary: Novolacs, being higher functionality resins, are useful as encapsulation formulas in electronics and chemically resistant coatings. Higher functionality provides steric hindrance for possible chemical attack. However, most likely this steric hindrance also prevents the molecules from fully reacting (negatively affecting strength). Use of novolacs did not bring a desired increase in strength. RDGE by contrast is a small molecule, of low viscosity (and can be added at any concentration), which freely reacts with amines providing a dense polymer network and higher strength. Applicants therefore conclude that a novolac-free composition is preferred, meaning a resin composition that contains no intentionally added novolac, so that any novolac is present only in trace amounts as an impurity.

TABLE 6
Effect of novolac content on compressive strength

| Formula | 4-071A | 4-071B | 4-071C | 4-071D |
|---|---|---|---|---|
| Part A | control | | | |
| Epon 862, % (Bis-F DGE) | 76 | 67.875 | 59.75 | 43.5 |
| Chemmod 68, % | 24 | 24 | 24 | 24 |
| Epon Su-8, % (epoxy novolac) | — | 8.125 | 16.25 | 32.5 |
| Kinematic viscosity, cPs | 670 | 1080 | 1810 | 5690 |
| Part B | | | | |
| Amine hardener, phr | 27.1 | 26.7 | 26.3 | 25.4 |
| Soichiometery, Resin >1 or A/B | 1 | 1 | 1 | 1 |
| ASTM C579B 7 day RT results, | | | | |
| compressive strength, psi | | | | |
| 1 | 23,810 | 23,998 | 23,356 | 23,560 |
| 2 | 22,972 | 23,527 | 23,411 | 22,846 |
| 3 | 23,340 | 23,717 | 23,686 | 22,928 |
| Average, psi | 23,340 | 23,750 | 23,480 | 23,110 |
| Standard deviation, psi | 350 | 193 | 144 | 319 |
| ASTM C579B postcure results, | | | | |
| compressive strength, psi | | | | |
| 1 | 28,187 | 26,786 | 27,060 | 25,988 |
| 2 | 28,048 | 27,323 | 27,321 | 26,007 |
| 3 | 27,751 | 27,241 | 27,299 | |
| Average, psi | 28,000 | 27,120 | 27,230 | 26,000 |
| Standard deviation, psi | 182 | 236 | 118 | 10 |

One suitable epoxy resin blend is a custom blend of bisphenol F, and neopentylglycoldiglycidyl ether, to which is added the desired amount of RDGE (preferably at least about 20 wt. % of the Part A). Those skilled in the art will appreciate that many other suitable epoxy systems are known, including any aromatic epoxy resins, such as: bisphenol A, bisphenol F, bisphenol E, aliphatic and aromatic mono- and di-glycidyl ethers thereof. For the present application, preferred epoxy resin blends typically have a viscosity in the range of 200 to 2000 cps.

Applicants speculate that the large strength improvements, documented in Tables 3-5, may be attributed, at least in part, to the molecular structure of the monomers, in particular the fact that a relatively weak bond exists between the two aromatic units in Bis-F. This weak bond is absent in RDGE because it only contains a single aromatic unit. There are a number of analogous monoaromatic monomers, including furfurylresorcinol glycidyl ether, o-cresol glycidyl ether, phenyl glycidyl ether, N,N-diglycidyl-4-glycidoxy aniline (DGGA) and others. To test the hypothesis that strength improvements might be a general benefit derived from using a monoaromatic monomer, Applicants explored the use of an aniline epoxy; in a later example it will be shown that this monomer did not provide beneficial results.

The remarkable compressive strength of the inventive materials, 30,000 to 33,000 psi, will allow structural designers to engineer new foundation structures. For example, in the foundation of a typical wind energy tower, the foundation consists of a reinforced concrete base, upon which a transition structure consisting of grout and a steel spreader plate is placed. The metal tower base is then bolted to the foundation, with the steel spreader plate acting to spread the loads generated by wind loading so that localized damage to the concrete and grout is avoided. For small towers, the steel spreader plate may not be needed; however the largest towers cannot, at present, be constructed without the spreader plate if conventional grout material is used.

### Example

As described in detail in Applicant's co-pending U.S. patent application Ser. No. 17/983,369 a transition structure is contemplated in which a grout ring may eliminate the need for a separate steel spreader plate, provided that several key requirements may be met: First, the grout must be sufficiently strong. Second, it must be sufficiently thick to adequately spread the load onto the underlying concrete. Third, it must be sufficiently well matched between the properties of steel and concrete so that issues such as differential thermal expansion do not arise. Representative material properties, Table 7, show that the inventive material can credibly replace the need for a steel ring in very large towers.

The inventive material not only provides a grout body that is strong enough to eliminate the need for the conventional steel ring, but further provides a better transition between the strength characteristics of the steel tower and the concrete foundation, and a better thermal expansion match. For this application, preferred values of CTE are no more than 14 μstrain/° F. and more preferably less than 11. The high solids loading of the inventive grouts typically produces a CTE as low as 9 μstrain/° F., whereas conventional grouts may have a CTE from 11 to 28 μstrain/° F.

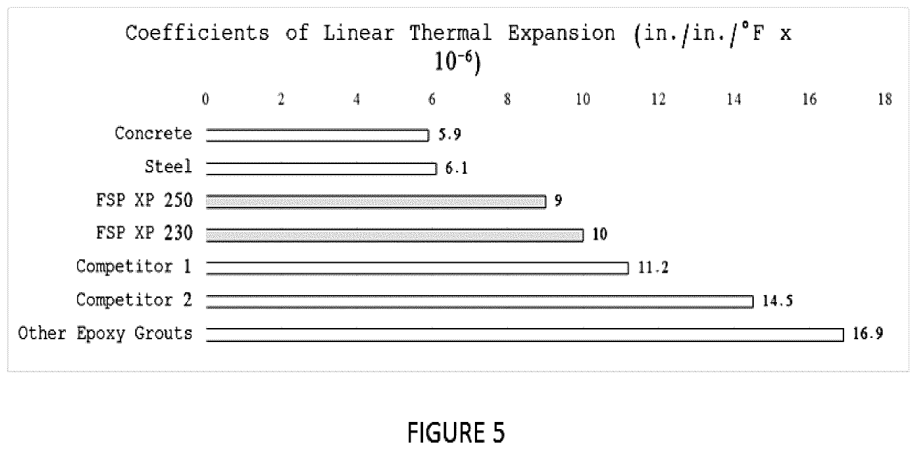

FIG. 5 compares the CTE of concrete, steel, and various epoxy grouts. In this chart, Competitor 1 is CHOCKFAST® Red and Competitor 2 is ESCOWELD 7505E/7530 (both from ITW Coatings, Montgomeryville, PA). FSP XP 230 is an UHS epoxy grout (Five Star Products, Shelton, CT; see also U.S. patent application Ser. No. 17/983,369). FSP XP 250 is the material of the present invention. One can see from FIG. 5 that the inventive grout reduces the CTE mismatch from ˜4 to ˜3 μstrain/° F. (about a 25% reduction) even compared to Applicant's earlier product; the improvement over the other grout materials shown is even more striking. The excellent CTE matching along with the extremely high compressive strength will allow the inventive material to be used in very large towers that cannot, at present, be constructed without a steel spreader plate.

TABLE 7
Comparative flexural and tensile strengths and elastic modulus of epoxy Grouts

| | Standard | HS Epoxy | UHS Epoxy^{d} | |
|---|---|---|---|---|
| | Epoxy Grout | Grout | Grout | This invention |
| Flexural | 4000 (27.6) | 5500 (37.9) | 6500 (44.8) | 5800 (40.0) |
| Strength, psi | | | | |
| (MPa)^{a} | | | | |
| Tensile | 2000 (13.8) | 2300 (15.8) | 2700 (18.6) | 2700 (18.6) |
| Strength, psi | | | | |
| (MPa)^{b} | | | | |
| Compressive | 2.5 × 10⁶ | 3.7 × 10⁶ | 5.4 × 10⁶ | not determined |
| Elastic Modulus, | (17.2) | (25.5) | (37.2) | |
| psi (MPa)^{c} | | | | |

^{a}Measured per ASTM C580
^{b}Measured per ASTM C307
^{c}Measured per ASTM C469 on a 3 × 6″ cylinder
^{d}U.S. patent application 17/983,369

Applicants were aware that the reaction rate of RDGE-based epoxies is extremely rapid, so much so that it is difficult to cast even a small test specimen of unfilled resin without experiencing visible thermal damage or charring of the material. For the contemplated application as a wind tower base, the grout ring might well be 15 cm or more in thickness. A cast body of such thickness would normally be impossible to form without massive thermal damage. However, Applicants have found that using a carefully sized aggregate, along with the relatively low-viscosity monomer system, it is possible to achieve a solids loading as high as 70% while maintaining acceptable fluidity, pumpability, and workability characteristics. Such high solids loading has two synergistic effects on the exotherm problem: first, a correspondingly lower fraction of resin creates less exotherm, and second, the large fraction of inorganic filler provides more heat capacity. The net result is that a ring can be cast of such thickness as to allow a very large tower (say, >105 m) to be bolted directly onto a sufficiently thick ring that the steel spreader plate is not needed. Structures of this size are not possible to achieve at present with existing grout formulations as are available in the industry.

Economic and engineering benefits of the invention.

As wind towers grow taller, and the turbines that sit atop them grow larger and heavier, the forces that exist at the base of the tower also grow larger. Typically, the construction of a tower starts with a concrete foundation topped with a thin layer of epoxy-based grout which then supports the steel tower. The grout layer provides a stable base for the tower, but it also typically spreads the load between the tower and the concrete foundation. As the towers get taller, and the resultant forces become greater, the addition of a steel bearing plate installed between the tower and the grout layer has become normal construction practice. The steel bearing plate is a larger diameter than the tower base and is several inches thick and thus serves to spread the load from the tower before the load must be borne by the grout layer. This is necessary because traditional grouts have maximum compressive strength of about 20,000 psi. The concrete foundation typically would have a compressive strength in the 5,000 psi to 6,000 psi range.

The inventive ultra-high compressive strength grouts enable the construction of tall wind towers without the use of a steel bearing plate. These materials with compressive strengths up to 26,000 to 33,000 psi are strong enough to directly bear the forces exerted by the tall towers. In addition, because the high volumetric loading of the inorganic filler, the exotherm on curing is reduced so significantly that the grout layer may be cast in place as a thick enough body to adequately spread the load between the tower and the concrete foundation.

The economic benefit from eliminating the bearing plate is significant as summarized in Table 8.

TABLE 8
Cost comparison of lower-strength grout plus steel spreader
plate versus ultra-high strength grout without steel plate.

| | Cost per tower |
|---|---|
| Normal Grout plus Bearing Plate | |
| Steel bearing plate | $30,000 |
| Normal grout | 5,000 |
| Total cost | $35,000 |
| UHS Grout without Bearing Plate | |
| Steel bearing plate | $0 |
| UHS grout | 25,000 |
| Total cost | $25,000 |

The skilled artisan can easily see that eliminating the bearing plate lowers the installed cost of the tower, ultimately improving the economic viability of the project and enabling more towers to be built profitably. For a project that has 100 towers the cost savings of $10,000 per tower would lower the total project cost by at least $1,000,000.

Other monoaromatic epoxy monomers.

A series of tests were conducted to check the usefulness of trigycidyl of para-aminophenol (ARA Xtreme PY 2100, Huntsman Corp., The Woodlands, TX 77380), Table 9. The higher functionality than RDGE was promising; with three glycidyl groups a tighter and therefore stronger network should be formed. However, Applicants found that adding as much as 40% of this monomer to the resin the mix did not improve the compressive strength. (This combined with the RDGE would mean that the resin blend would comprise 90% of monoaromatic multi-glycidyl ethers). As seen from Table 9, Formula B has only 55% of monoaromatic epoxy and it is higher in strength. In comparison column C shows how 90% of monoaromatic epoxy (RDGE) increases the strength. Comparing column A to C it became clear that the aniline epoxy is deleterious to the development of optimal strength. The work with ARA Xtreme PY 2100 was abandoned and Applicants concluded that the results obtained using RDGE may not be generalized to all monoaromatic monomers. Applicants further noticed an adverse impact on resin shelf life.

TABLE 9
Comparison of grouts made with RDGE with and without
another monoaromatic monomer in the blend. Values
are normalized to 100 g epoxy in Part A.

| | A | B | C |
|---|---|---|---|
| Part A | | | |
| RDGE, g | 50.0 | 55.0 | 90.0 |
| ARA Xtreme PY2100, g | 40.0 | — | — |
| NPG-DGE, g | 10 | 10.0 | 10 |
| EPON 862, g | — | 35.0 | — |
| Part B | | | |
| FSP Amine Hardener, g | 40.2 | 33.8 | 38.5 |
| Part C | | | |
| FSP XP 230 aggregate, g | 1465 | 1465 | 1465 |
| Stoichiometry, A/B | 1.00 | 1.00 | 1.00 |
| Postcure compressive, psi | 29,590 | 30,280 | 32,020 |

We claim:

1. A three part polymer grout composition comprising:
a liquid epoxy resin comprising at least 20 wt. % resorcinol diglycidyl ether, the resin being substantially free of novolac;
a liquid curing agent; and,
a dry particulate filler comprising particles having a blend of particle sizes and amounting to at least 70% of the combined volume of the particulate filler, the resin, and the hardener; and,
wherein the polymer grout has a compressive strength at 28 days of at least 23,000 psi.

2. The grout composition of claim 1 wherein:
the liquid epoxy resin comprises at least 50 wt. % resorcinol diglycidyl ether, and,
the polymer grout has a compressive strength at 28 days of at least 25,000 psi.

3. The grout composition of claim 1 wherein the liquid epoxy resin comprises at least one compound selected from the group consisting of: diglycidyl ether epoxy resins of bisphenol A, bisphenol F, bisphenol E, bisphenol S, and reactive diluents including aliphatic and aromatic mono-di- and tri-glycidyl ethers thereof.

4. The grout composition of claim 1 wherein the liquid hardener comprises a material selected from the group consisting of: cyclohexanemethanamine, 5-amino-1,3,3-trimethyl-, any cycloaliphatic mono-, di-, and tri-amine, isophoronediamine (IPDA), aliphatic amines, and aromatic amines.

5. The grout composition of claim 1 wherein at least one of the liquid epoxy blend and the liquid hardener further comprises a surfactant selected from the group consisting of: Modaflow acrylic copolymer, 2,6-dimethylheptan-4-one, 4,6-dimethyl-2-heptanone, mineral oil, and benzyl alcohol.

6. The grout composition of claim 1 wherein the dry particulate filler further comprises 0.1 to 2 wt. % of an adhesion promoter selected from the group consisting of: amino functional silanes, glycidoxy functionalized silanes, (meth)acrylic functionalized silanes, and other reactive functionalized silanes.

7. The grout composition of claim 1 wherein the dry particulate filler comprises:
coarse sand in a size range of −6+16 mesh;
intermediate sand in a size range of −16+40 mesh;
fine sand in a size range of −40+140 mesh; and,
fine filler.

8. The grout composition of claim 7 wherein the dry particulate filler comprises:
30-70 wt. % coarse sand in a size range of −6+16 mesh;
10-40 wt. % intermediate sand in a size range of −16+40 mesh;
5-30 wt. % fine sand in a size range of −40+140 mesh; and,
balance fine filler.

9. The grout composition of claim 7 wherein the fine filler comprises fly ash.

10. The grout composition of claim 1 characterized by the following properties in the fully cured state:
compressive strength at least 23,000 psi;
coefficient of thermal expansion no more than 14 μstrain/° F.;
elastic modulus at least 24 GPa.

11. The grout composition of claim 10 further characterized by having sufficient mechanical and thermal properties in the fully cured state that it can form a complete transition structure at least 15 cm thick between a reinforced concrete foundation and a wind tower base without the need for a steel spreader ring between the grout and the tower base.

12. A polymer grout transition structure for a tower comprising:
a cast in place polymer grout ring having selected inner and outer diameters and a selected thickness of at least 6 inches, and a compressive strength at 28 days of at least 23,000 psi, wherein:
the polymer grout comprises a three-part system of resin, hardener, and aggregate, wherein the resin component of the polymer grout comprises at least 20 wt. % of a diglycidyl ether of a monoaromatic monomer and is substantially free of novolac; and,
the polymer grout contains at least 70% by volume of inorganic aggregate.

13. The polymer grout transition structure of claim 12 wherein the monoaromatic monomer comprises resorcinol.

14. The polymer grout transition structure of claim 12 wherein the dry particulate filler comprises:
coarse sand in a size range of −6+16 mesh;
intermediate sand in a size range of −16+40 mesh;
fine sand in a size range of −40+140 mesh; and,
fine filler.

15. The polymer grout transition structure of claim 12 wherein the grout ring is cast in place on a reinforced concrete pad with two concentric rings of upwardly projecting bolts passing therethrough.

16. A foundation system for a tower comprising:
a cast in place reinforced concrete foundation comprising two concentric rings of bolts extending a selected distance upward from its upper surface;
a cast in place polymer grout ring formed on top of the foundation and extending a first selected distance outward beyond the outer concentric ring, a second selected distance inward beyond the inner concentric ring, and a third selected distance of at least 6 inches upward, leaving the two concentric rings of bolts partially exposed above the grout so that a metal tower may be bolted directly upon the polymer grout;
wherein:
the reinforced concrete has a compressive strength of at least 3000 psi;
the polymer grout has a compressive strength at 28 days of at least 25,000 psi;
the polymer grout comprises a three-part system of resin, hardener, and aggregate, wherein the resin component of the polymer grout comprises at least 20 wt. % of a diglycidyl ether of a monoaromatic monomer; and,
the polymer grout contains at least 70% by volume of inorganic aggregate.

17. The polymer grout transition structure of claim 16 wherein the monoaromatic monomer comprises resorcinol.

18. The polymer grout transition structure of claim 16 wherein the dry particulate filler comprises:
coarse sand in a size range of −6+16 mesh;
intermediate sand in a size range of −16+40 mesh;
fine sand in a size range of −40+140 mesh; and,
fine filler.
